(19) United States
(12) Patent Application Publication
(10) Pub. No.: US 2026/0193866 A1
(43) Pub. Date: Jul. 9, 2026

(54) PLUG-IN HYBRID ARCHITECTURE FOR OFF-HIGHWAY MACHINES

(71) Applicant: Deere & Company, Moline, IL (US)

(72) Inventors: NILESH T. KUMBHAR, Karad (IN); ZIMIN W. VILAR, Dubuque, IA (US)

(21) Appl. No.: 19/011,199

(22) Filed: Jan. 6, 2025

(51) Int. Cl. E02F 9/20; B60K 6/24; B60K 6/26; B60K 6/387; B60K 6/40; B60K 6/442; E02F 3/76; E02F 9/02; E02F 9/22; H02K 7/116

(52) U.S. Cl. CPC E02F 9/2075; B60K 6/24; B60K 6/26; B60K 6/387; B60K 6/40; B60K 6/442; E02F 9/02; E02F 9/2091; E02F 9/2095; E02F 9/2253; B60Y 2200/20; B60Y 2200/41; B60Y 2200/92; E02F 3/7609; H02K 7/116

(57) ABSTRACT

A system and a method control the energy provided to an off-highway machine having terrain-engagement members to move the machine and having hydraulic cylinders to move a material manipulation implement. An internal combustion engine (ICE) and a motor/generator are selectively coupled to a gearbox by respective clutches. A hydrostatic pump and a hydraulic pump are coupled to the gearbox to receive energy from the gearbox. The machine can operate in an electric-only mode wherein only the motor/generator provides energy to the two pumps via the gearbox; in an engine-only mode wherein only the ICE provides energy to the two pumps via the gearbox; and in a hybrid mode wherein the ICE provides energy to the gearbox and wherein the motor/generator selectively operates as a motor to provide additional energy to the gearbox or as a generator to receive energy from the ICE via the gearbox.

### FIELD OF THE DISCLOSURE

This disclosure relates to a system and method for managing the power provided to the traction motors and the power provided to the hydraulic system of off-highway machines and agricultural machines using plug-in hybrid architecture.

### BACKGROUND

Off-highway machines are used to move bulk materials at construction sites and the like. Off-highway machines are also used in agriculture to prepare fields, plant and maintain crops, harvest and transport crops, and the like. The machines generally have large wheels or tracks as terrain-engagement members to enable the machines to move on uneven terrain. The machines serve as mobile support platforms for hydraulically powered implements attached to the machines. The attached implements manipulate materials. For example, certain implements engage soil or other materials and move the soil or other materials to other locations. The attached implements may push or pull the materials to different locations on the terrain using a blade such as a blade on a dozer or grader. The attached implements may remove the material from the terrain using a bucket or other similar implement and carry the material to a new location, either directly or by transferring the material to a transport vehicle such as a truck. Other types of implements include grinders that transform bulk material (e.g., trees, used concrete or pavement, or the like) into smaller sized material.

Many off-highway machines are powered by internal combustion engines (ICEs) such as diesel engines. An ICE may also be referred to herein as a prime mover. An ICE may power the wheels or tracks of the machine directly via gearboxes and the like; however, many machines drive the wheels or tracks using a hydrostatic pump that generates fluid flow to run hydrostatic motors that are connected to the wheels or tracks. The hydrostatic pump is driven by the ICE. The ICE also drives a hydraulic pump that provides hydraulic fluid flow to operate hydraulic cylinders and/or motors that operate the hydraulic powered implements attached to the machine. The ICE may drive the hydraulic pump directly or may drive the hydraulic pump indirectly via the hydro static pump.

Because of environmental concerns and economical concerns, hybrid technology is becoming more common in transportation vehicles such as personal vehicles and smaller trucks; however, hybrid technology is less commonly used in off-highway machines.

### SUMMARY

A need exists for incorporating hybrid technology into off-highway machines.

One aspect of the embodiments disclosed herein is a system and a method that control the energy provided to an off-highway machine having terrain-engagement members to move the machine and having hydraulic cylinders to move a material manipulation implement. An internal combustion engine (ICE) and a motor/generator are selectively coupled to a gearbox by respective clutches. A hydrostatic pump and a hydraulic pump are coupled to the gearbox to receive energy from the gearbox. The off-highway machine can operate in an electric-only mode wherein only the motor/generator provides energy to the two pumps via the gearbox, in an engine-only mode wherein only the ICE provides energy to the two pumps via the gearbox; and in a hybrid mode wherein the ICE provides energy to the gearbox and wherein the motor/generator selectively operates as a motor to provide additional energy to the gearbox or as a generator to receive energy from the ICE via the gearbox.

Another aspect of the embodiments disclosed herein is a hybrid power generation system for an off-highway machine having traction motors for moving the off-highway machine over terrain and having at least one hydraulically powered implement for moving materials. The hybrid power generation system comprises a gearbox. A hydrostatic pump is mechanically coupled to the gearbox and is hydrostatically coupled to the traction motors. A hydraulic pump is mechanically coupled to the gearbox and is hydraulically coupled to the hydraulically powered implement. The system further includes an internal combustion engine. A first clutch is coupled to the engine and is coupled to the gear box. The first clutch is selectively engageable to mechanically couple the engine to the gearbox. The system further includes a motor/generator. A second clutch is coupled to the motor/generator and is coupled to the gear box. The second clutch is selectively engageable to mechanically couple the motor/generator to the gearbox. An energy storage system is electrically coupled to the motor/generator. A control system is configured to control the first clutch and the second clutch to provide multiple modes of operation. In a first mode of operation, the first clutch is engaged to couple the engine to the gearbox, and the second clutch is engaged to couple the motor/generator to the gearbox. In a second mode of operation, the first clutch is disengaged to decouple the engine from the gearbox, and the second clutch is engaged to couple the motor/generator to the gearbox. In a third mode of operation, the first clutch is engaged to couple the engine to the gearbox, and the second clutch is disengaged to decouple the motor/generator from the gearbox.

In certain embodiments in accordance with this aspect, in the first mode of operation, the motor/generator is selectively operable as an electrical motor to provide mechanical energy to the gearbox in addition to energy from the engine, and the motor/generator is selectively operable as an electrical generator to receive mechanical energy from the engine via the gearbox to enable the motor/generator to generate electrical energy to store in the energy storage system.

In certain embodiments in accordance with this aspect, in the second mode of operation, the motor/generator is the only source of mechanical energy provided to the gearbox.

In certain embodiments in accordance with this aspect, in the third mode of operation, the engine is the only source of mechanical energy provided to the gearbox.

In certain embodiments in accordance with this aspect, the system includes an input port to the energy storage system that enables the energy storage system to be coupled to an external source of energy to store in the energy storage system.

In certain embodiments in accordance with this aspect, the system further comprises a bidirectional inverter that electrically couples the energy storage system to the motor/generator. The bidirectional inventor operates in a first conversion mode to convert DC electrical energy from the energy storage system to AC electrical energy to operate the motor/generator as a motor and thereby provide mechanical energy to the gearbox. The bidirectional inverter operates in a second conversion mode to convert AC electrical energy from the motor/generator to DC electrical energy to store in the energy storage system.

In certain embodiments in accordance with this aspect, the system further comprises electrically powered accessories coupled to the energy storage system.

In certain embodiments in accordance with this aspect, the energy storage system comprises at least one battery.

Another aspect of the embodiments disclosed herein is a method of operating a hybrid off-highway machine having traction motors for moving the off-highway machine over terrain and having at least one hydraulically powered implement for moving materials. The method couples a gearbox to a hydrostatic pump to drive the at least one traction motor and couples the gearbox to a hydraulic pump to drive the hydraulically powered implement. The method electrically couples a motor/generator to an energy storage system. The method selectively operates the engine and the motor/generator to provide energy to the traction motors and to the hydraulically powered implement in one of a hybrid mode; an electric-only mode; and an engine only mode.

In certain embodiments in accordance with this aspect, operating in the hybrid mode comprises engaging a first clutch to couple an internal combustion engine to the gearbox, engaging a second clutch to couple the motor/generator to the gearbox, and responding to energy required to drive the hydrostatic pump and the hydraulic pump by selectively operating the motor/generator as a motor or as a generator. When operated as a motor, the motor/generator receives electrical energy from the energy storage system and that provides additional mechanical energy to the gearbox. When operated as a generator, the motor/generator receives mechanical energy from the gearbox and generates electrical energy to store in the energy storage system.

In certain embodiments in accordance with this aspect, operating in the electric-only mode comprises disengaging the first clutch and engaging the second clutch to provide mechanical energy to the gearbox only from the motor/generator operating as a motor.

In certain embodiments in accordance with this aspect, operating in the engine-only mode comprises disengaging the second clutch and engaging the first clutch to provide energy to the gearbox only from the engine.

In certain embodiments in accordance with this aspect, the method further comprises selectively providing electrical energy to the energy storage system from an external source of electrical energy.

Numerous objects, features, and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 illustrates a perspective view of an exemplary off-highway machine into which the improvements disclosed herein can be incorporated.

FIG. 2 illustrates a partially broken, elevational side view of the off-highway machine of FIG. 1 showing internal components of the hybrid architecture.

FIG. 3 illustrates a perspective view of the internal combustion engine of the off-highway machine of FIGS. 1 and 2 showing the gearbox coupled to the internal combustion engine and showing the motor/generator, the hydrostatic pump, and the hydraulic pump coupled to the gear box.

FIG. 4 illustrates an exploded perspective view of the internal combustion engine, gearbox, motor/generator, hydrostatic pump, and hydraulic pump of FIG. 3.

FIG. 5 illustrates a block diagram of the hybrid architecture of the off-highway machine of FIGS. 1 and 2.

FIG. 6 illustrates a flowchart of the method of operating the off-highway machine of FIGS. 1 and 2.

### DETAILED DESCRIPTION

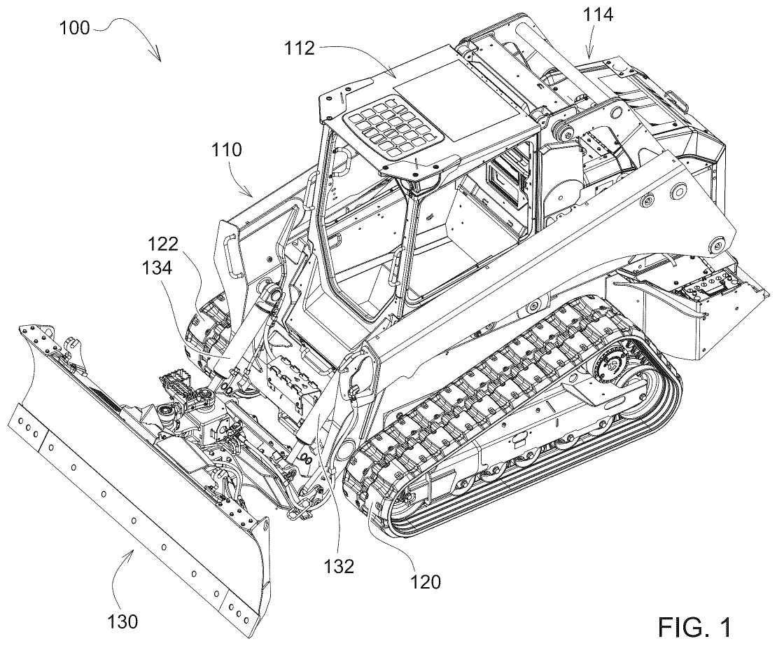

FIG. 1 illustrates a perspective view of an exemplary off-highway machine 100 into which the improvements disclosed herein may be incorporated. The illustrated off-highway machine is embodied as a compact track loader (CTL) (hereinafter “loader”); however, the improvements may also be incorporated into other types of off-highway machines such as dozers, graders, excavators, earthmovers, agricultural machines, and the like. Such off-highway machines can have tracks operating as terrain-engagement members to enable the machines to move on uneven surfaces. The off-highway machines can also have large wheels instead of tracks. The off-highway machines provide a movable platform for material-handling implements such as dozer blades, grader blades, loader buckets, excavator buckets that engage material such as dirt, gravel, rocks, trees, and the like, and move the material from a first location to a second location.

The illustrated loader 100 of FIG. 1 includes a main structure 110, which encompasses an operator cab 112 and a power generation compartment 114. The main structure is moved by a first terrain-engagement member 120 and a second terrain-engagement member 122, which are mounted on opposing sides of the main structure. The terrain-engagement members in FIG. 1 are illustrated as continuous tracks in the CTL embodiment. In alternative embodiments (not shown), the tracks of FIG. 1 can be replaced by a respective front wheel and a respective rear wheel on each side of the main structure to provide a skid loader configuration.

In the illustrated embodiment, the loader 100 includes a work implement 130 that is coupled to a front portion of the main structure 110. The work implement is illustrated as a conventional dozer blade that can be raised and lowered via a first hydraulic cylinder 132, and a second hydraulic cylinder 134. In other embodiments (not shown) the work implement can be, for example, a bucket that can be raised and lowered and that can also be tilted via additional hydraulic cylinders (not shown).

In a conventional loader, the terrain engagement members are driven by an internal combustion engine (ICE). For example, the ICE can drive at least one hydrostatic pump that provides hydraulic flow to at least one hydrostatic motor for each ground engagement member. The ICE also drives at least one hydraulic pump that provides hydraulic flow to operate the hydraulic cylinders to raise and lower the work implement and to tilt the work implement when the work implement is implemented as a bucket.

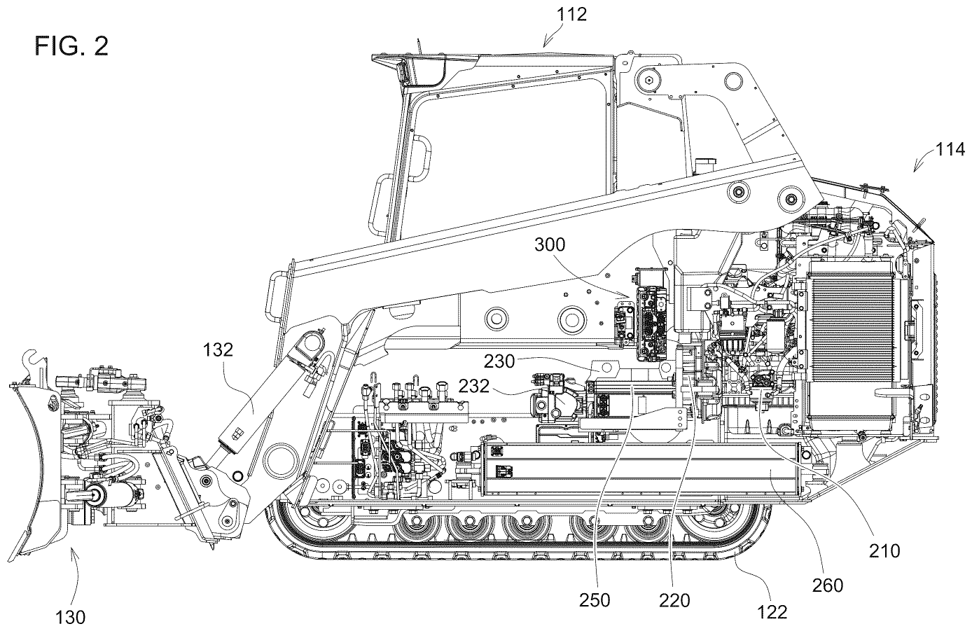

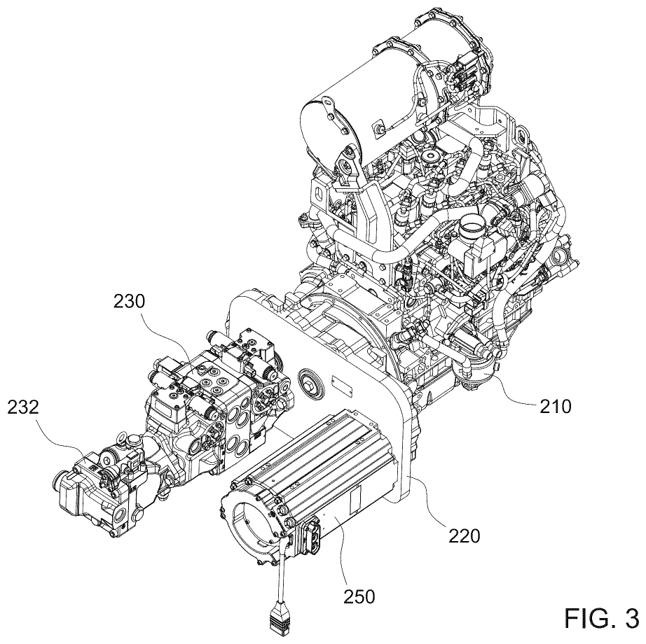

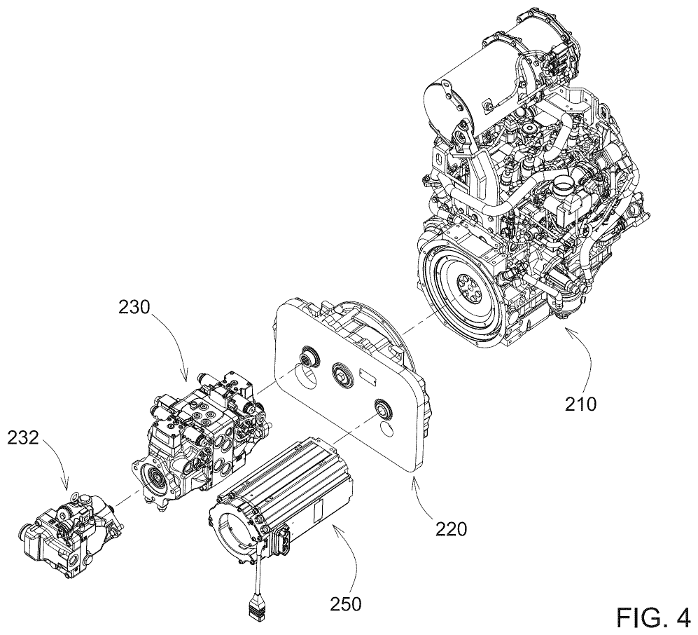

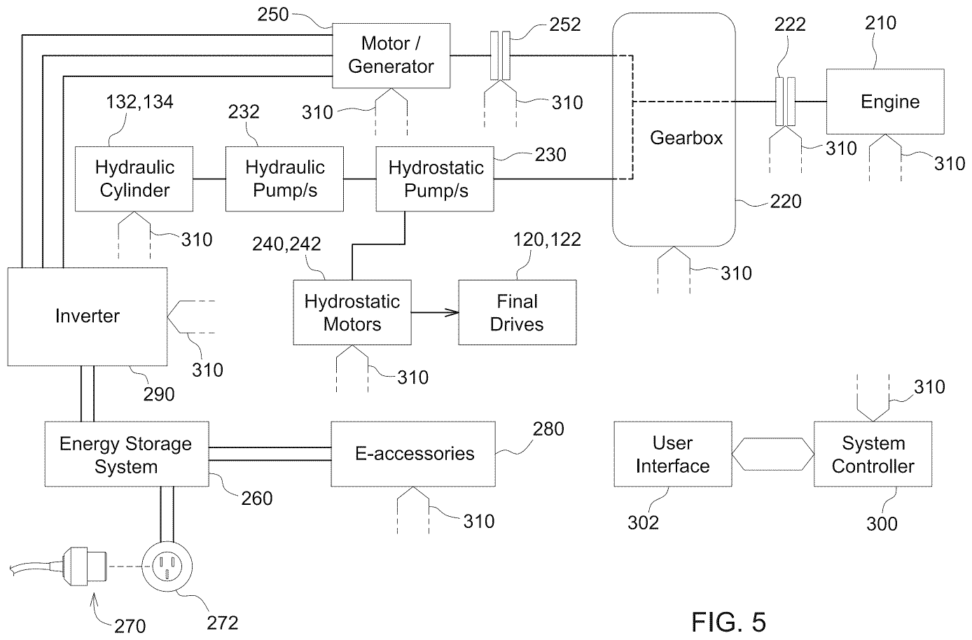

Unlike a conventional loader, the loader 100 of FIGS. 1 and 2 is configured with a hybrid power generation system 200, which is shown in a perspective view in FIG. 3, in an exploded perspective view in FIG. 4, and in a schematic block diagram in FIG. 5. The power generation system includes an internal combustion engine (ICE) 210 (also shown in FIG. 2). The ICE is coupled to a gearbox 220 via an electrically operated engine clutch 222 (see FIG. 5). The engine clutch can be selectively engaged to provide mechanical energy from the ICE to the gearbox and can be selectively disengaged to decouple the ICE from the gearbox.

As further shown in FIGS. 3, 4 and 5, a hydrostatic transmission (HST) pump 230 is mounted to the gearbox 220 and is coupled to the gearbox to receive rotational mechanical energy from the gearbox. A hydraulic pump 232 is also mounted to the gearbox and is coupled to the gearbox to receive rotational mechanical energy from the gearbox. Although the hydraulic pump could be mounted directly onto the gearbox, the hydraulic pump and the HST pump are mounted in tandem in the illustrated embodiment such that the rotational mechanical energy from the gearbox is provided to both pumps from a single output of the gearbox.

The hydraulic pump 232 is responsive to the rotational mechanical energy from the gearbox 220 to produce hydraulic fluid flow. As illustrated schematically in FIG. 5, the hydraulic fluid flow is selectively coupled to the hydraulic cylinders 132, 134 to move the implement 130 in a conventional manner. The hydraulic flow can also be coupled to other hydraulically powered components (not shown).

The HST pump 230 is responsive to the rotational mechanical energy from the gearbox 220 to produce hydrostatic fluid flow. As illustrated in FIG. 5, the hydrostatic fluid flow from the HST pump is coupled to at least a first hydrostatic transmission (HST) motor 240 and at least a second HST motor 242, which drive the first terrain-engagement member 120 and the second terrain-engagement member 122, respectively.

As shown in FIGS. 3, 4, and 5, a motor/generator 250 is also mounted to the gearbox 220. The motor/generator includes an electrically operated motor/generator clutch 252 (see FIG. 5) that can be selectively engaged to couple the motor/generator to the gearbox and that can be selectively disengaged to decouple the motor/generator from the gearbox. The motor/generator clutch can be incorporated into the motor/generator or can be a separate device (not shown) interposed between the motor/generator and the gearbox. As discussed below, the motor/generator can be operated as a motor to receive electrical energy as an input and to provide rotational mechanical energy as an output to the gearbox. The motor/generator can also be operated as a generator to receive rotational mechanical energy as input from the gearbox and to generate electrical energy as an output.

As further illustrated in FIGS. 2 and 5, the hybrid power generation system 200 includes an energy storage system 260, which is implemented as a battery system in the illustrated embodiment. For example, the energy storage system can comprise a plurality of batteries coupled together in a series-parallel configuration to provide a DC output voltage having a desired magnitude. For example, the energy storage system can have an output voltage having a magnitude that can be in a range from less than a hundred volts up to multiple hundreds of volts. As illustrated in FIG. 5, the energy storage system receives power from an external source 270 via an input port 272. The external source can be a DC source for rapidly charging the energy storage system. The external source can be an AC source and a voltage conversion system (not shown) to charge the energy storage system at a slower rate. In some embodiments, the energy storage system can receive energy from either a DC source or an AC source.

The energy storage system 260 is coupled to electronic accessories (E-accessories) 280 such as lighting, heating, instrumentation, communications, and the like. The electronic accessories can be coupled to the energy storage system via one or more DC-DC converters (not shown) to reduce the DC output voltage of the energy storage system to a conventional output voltage (e.g., 12 volts or greater).

In the illustrated embodiment, the energy storage system 260 is coupled to the motor/generator 250 via a bidirectional inverter 290. When the motor/generator is operated as a motor, the inverter receives DC electrical energy from the energy storage system and generates AC electrical energy to provide to the motor/generator. When the motor/generator is operated as generator, the inverter receives AC electrical energy from the motor/generator and converts the energy to DC electrical energy to store in the energy storage system. In the illustrated embodiment, the AC electrical energy is conventional three-phase electrical energy.

As further illustrated in FIG. 5, the hybrid power generation system 200 includes a system controller 300 coupled to a user interface 302. The user interface represents controls in the operator cab 112 that an operator can manipulate to control the operations of the loader 100. The system controller is responsive to user commands from the user interface to issue control commands to the ICE 210, to the gearbox 220, to the engine clutch 222, to the motor/generator clutch 252, to a hydraulic controller (not shown) that controls the hydraulic cylinders 132, 134, and to the hydrostatic motors 240. In the illustrated embodiment, the system controller is coupled to the controlled components via a conventional controller area network (CAN) bus 310. The system controller also receives information from the controlled components via the CAN bus. The system controller is responsive to the received information to confirm proper operation of the controlled components and to make any adjustments to the operation of the controlled components.

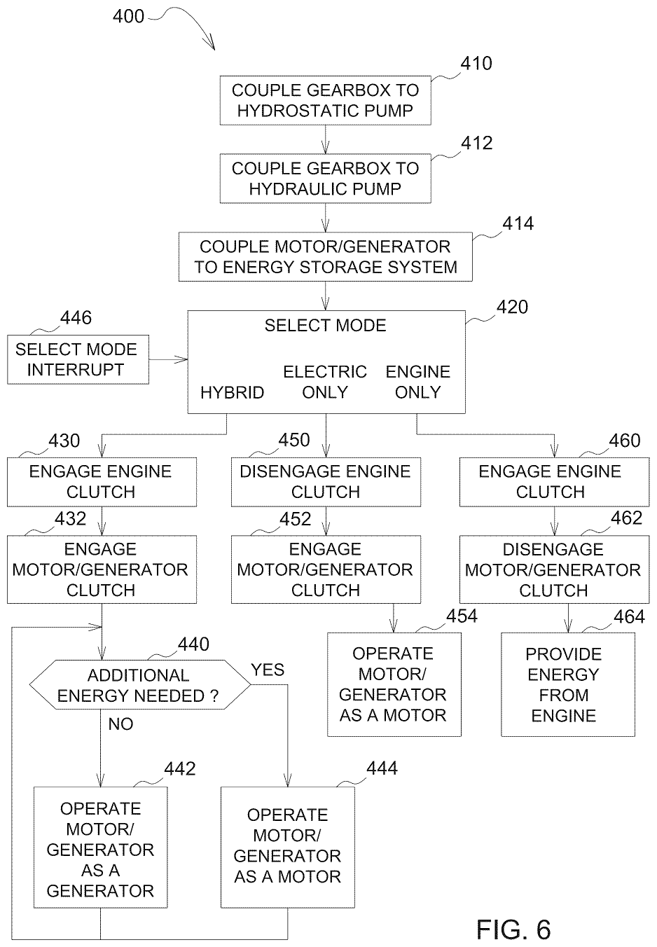

The hybrid power generation system 200 operates in three modes in accordance with a method illustrated by a flowchart 400 of FIG. 6. As part of the configuration of the system architecture, the gearbox 220 is coupled to the hydrostatic pump 230 as represented by a first configuration action block 410. The gearbox is also coupled to the hydraulic pump 232 as represented by a second configuration action block 412. The motor/generator 250 is coupled to the energy storage system 260 via the bidirectional inverter 290 as represented by a third configuration action block 414.

When the loader 100 is operated, a mode of operation is selected in a mode selection block 420. Within the mode selection block, the method allows an operator to select one of three modes of operation: a hybrid mode of operation; an electric-only mode of operation; and an engine-only mode of operation.

If the hybrid mode of operation is selected, the method advances from the mode selection block 420 to a first hybrid mode action block 430 wherein the system controller 300 sends commands to the engine clutch 222 via the CAN bus 310 to engage the engine clutch and thereby couple the ICE 210 to the gearbox 220. The method advances to a second hybrid mode action block 432 wherein the system controller sends commands to the motor/generator clutch 252 via the CAN bus to engage the moto/generator clutch and thereby couple the motor/generator 250 to the gearbox.

After engaging the two clutches 222, 252, the method advances to a hybrid mode decision block 440 wherein the system controller 300 determines whether the ICE 210 is able to provide sufficient mechanical energy to the hydrostatic pump 230 and the hydraulic pump 232 under the current operating conditions. If additional energy is needed, the method advances from the hybrid mode decision block to a third hybrid mode action block 442 wherein the system controller commands the motor/generator 250 to operate as a motor to provide additional mechanical energy to the gearbox 220 and thereby provide additional mechanical energy to the hydrostatic pump and the hydraulic pump. If no additional energy is needed, the method advances from the hybrid mode decision block to a fourth hybrid mode action block 444 wherein the system controller commands the motor/generator to operate as a generator to receive mechanical energy from the ICE via the gearbox and to generate electrical energy to store in the energy storage system 260 via the inverter 290.

After the system controller 300 configures the motor/generator 250 as a motor in the third hybrid mode action block 442 or configures the motor/generator as a generator in the fourth hybrid mode action block 444, the method returns to the hybrid mode decision block 440 to continue to determine whether additional mechanical energy is needed from the motor/generator. The method continues in this loop until interrupted. For example, an operator may change the mode of operation via the user interface 302, which causes an interrupt operation (represented by a select mode interrupt block 446) to occur within the system controller to cause the method to return to the mode selection block 420.

If the electric-only mode of operation is selected in the mode selection block 420, the method advances from the mode selection block to a first electric-only action block 450 wherein the system controller 300 sends commands to the engine clutch 222 via the CAN bus 310 to disengage the engine clutch and thereby decouple the ICE 210 from the gearbox 220. The method advances to a second electric-only action block 452 wherein the system controller sends commands to the motor/generator clutch 252 via the CAN bus to engage the moto/generator clutch and thereby couple the motor/generator 250 to the gearbox.

After disengaging the engine clutch 222 and engaging the motor/generator clutch 252, the method advances to a third electric-only action block 454 wherein the system controller 300 configures the motor/generator 250 as a motor to thereby provide mechanical energy from the motor/generator to the pumps 230, 232 via the gearbox 220. The method remains in the third electric-only action block until interrupted by a change in the mode of operation that returns the method to the action block 420 via the select mode interrupt block 446 as described above.

If the engine-only mode of operation is selected in the mode selection block 420, the method advances from the mode selection block to a first engine-only action block 460 wherein the system controller 300 sends commands to the engine clutch 222 via the CAN bus 310 to engage the engine clutch and thereby couple the ICE 210 to the gearbox 220. The method advances to a second engine-only action block 462 wherein the system controller sends commands to the motor/generator clutch 252 via the CAN bus to disengage the moto/generator clutch and thereby decouple the motor/generator 250 from the gearbox. The engine-only mode of operation can be selected, for example, when the operator knows the energy storage system 260 is fully charged and also knows that the total mechanical energy required can be provided by the ICE without assistance of the motor/generator.

After engaging the engine clutch 222 and disengaging the motor/generator clutch 252, the method advances to a third engine-only action block 464 wherein the system controller operates the ICE 210 to provide mechanical energy to the pumps 230, 232 via the gearbox 220. The method remains in the third engine-only action block until interrupted by a change in the mode of operation that returns the method to the action block 420 via the select mode interrupt block 446 as described above.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

1. A hybrid power generation system for an off-highway machine having traction motors for moving the off-highway machine over terrain and having at least one hydraulically powered implement for moving materials, the hybrid power generation system comprising:
a gearbox;
a hydrostatic pump mechanically coupled to the gearbox and hydrostatically coupled to the traction motors;
a hydraulic pump mechanically coupled to the gearbox and hydraulically coupled to the hydraulically powered implement;
an internal combustion engine;
a first clutch coupled to the engine and coupled to the gearbox, the first clutch selectively engageable to mechanically couple the engine to the gearbox;
a motor/generator;
a second clutch coupled to the motor/generator and coupled to the gearbox, the second clutch selectively engageable to mechanically couple the motor/generator to the gearbox;
an energy storage system electrically coupled to the motor/generator;
a control system configured to control the first clutch and the second clutch to provide multiple modes of operation, wherein:
in a first mode of operation, the first clutch is engaged to couple the engine to the gearbox, and the second clutch is engaged to couple the motor/generator to the gearbox;
in a second mode of operation, the first clutch is disengaged to decouple the engine from the gearbox, and the second clutch is engaged to couple the motor/generator to the gearbox; and
in a third mode of operation, the first clutch is engaged to couple the engine to the gearbox, and the second clutch is disengaged to decouple the motor/generator from the gearbox.

2. The hybrid power generation system of claim 1 wherein in the first mode of operation:
the motor/generator is selectively operable as an electrical motor to provide mechanical energy to the gearbox in addition to energy from the engine; and
the motor/generator is selectively operable as an electrical generator to receive mechanical energy from the engine via the gearbox to enable the motor/generator to generate electrical energy to store in the energy storage system.

3. The hybrid power generation system of claim 1 wherein in the second mode of operation, the motor/generator is the only source of mechanical energy provided to the gearbox.

4. The hybrid power generation system of claim 1 wherein in the third mode of operation, the engine is the only source of mechanical energy provided to the gearbox.

5. The hybrid power generation system of claim 1 further comprising an input port to the energy storage system that enables the energy storage system to be coupled to an external source of energy to store in the energy storage system.

6. The hybrid power generation system of claim 1 further comprising a bidirectional inverter that electrically couples the energy storage system to the motor/generator, the bidirectional inventor operating in a first conversion mode to convert DC electrical energy from the energy storage system to AC electrical energy to operate the motor/generator as a motor and thereby provide mechanical energy to the gearbox, the bidirectional inverter operating in a second conversion mode to convert AC electrical energy from the motor/generator to DC electrical energy to store in the energy storage system.

7. The hybrid power generation system of claim 1 further comprising electrically powered accessories coupled to the energy storage system.

8. The hybrid power generation system of claim 1 wherein the energy storage system comprises at least one battery.

9. A method of operating a hybrid off-highway machine having traction motors for moving the off-highway machine over terrain and having at least one hydraulically powered implement for moving materials, the method comprising:
coupling a gearbox to a hydrostatic pump to drive the traction motors;
coupling the gearbox to a hydraulic pump to drive the hydraulically powered implement;
electrically coupling a motor/generator to an energy storage system; and
selectively operating the engine and the motor/generator to provide energy to the traction motors and to the hydraulically powered implement in one of:
a hybrid mode;
an electric-only mode; and
an engine only mode.

10. The method of operating a hybrid off-highway machine of claim 9 wherein operating in the hybrid mode comprises:
engaging a first clutch to couple an internal combustion engine to the gearbox;
engaging a second clutch to couple the motor/generator to the gearbox; and
responding to energy required to drive the hydrostatic pump and the hydraulic pump by selectively operating the motor/generator as a motor that receives electrical energy from the energy storage system and that provides additional mechanical energy to the gearbox or by selectively operating the motor/generator as a generator that receives mechanical energy from the gearbox and that generates electrical energy to store in the energy storage system;

11. The method of operating a hybrid off-highway machine of claim 9 wherein operating in the electric-only mode comprises:
disengaging the first clutch; and
engaging the second clutch to provide mechanical energy to the gearbox only from the motor/generator operating as a motor;

12. The method of operating a hybrid off-highway machine of claim 9 wherein operating in the engine-only mode comprises:
disengaging the second clutch; and
engaging the first clutch to provide energy to the gearbox only from the engine.

13. The method of operating a hybrid off-highway machine of claim 9 further comprising selectively providing electrical energy to the energy storage system from an external source of electrical energy.
